(19) United States
(12) Patent Application Publication
(10) Pub. No.: US 2008/0275630 A1
(43) Pub. Date: Nov. 6, 2008

(54) Venue Guiding Assistance System, Apparatus and Method

(75) Inventor: Brian Regienczuk, Atlanta, GA (US)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics, N.V., Eindhoven (NL)

(21) Appl. No.: 10/599,380

(22) PCT Filed: Mar. 30, 2005
(86) PCT No.: PCT/IB05/51041

§ 371 Date: Sep. 27, 2006

Related U.S. Application Data
(60) Provisional application No. 60/557,501, filed on Mar. 30, 2004.
(60) Provisional application No. 60/591,406, filed on Jul. 27, 2004.

(51) Int. Cl. G01C 21/00; G06Q 99/00

(52) U.S. Cl. 701/200; 705/1

(57) ABSTRACT

An interactive system, apparatus and/or method for operative use within a venue (10) is provided. The system and/or apparatus include data processing means (20, 54), data storing means (22, 56), communicating means (30, 52), and guiding means (40, 58), all of which cooperate to enable one or more individuals to interact with the venue in real time while at the venue. The system and/or apparatus can also have person and/or product tracking means to optimally direct individuals to one or more items of interest within the venue. Individuals can use the system and/or apparatus to provide the venue with pertinent information as well as to receive responsive feedback and/or direction as desired.

This patent application is related to and claims the benefit of co-pending U.S. Patent Application accorded Ser. No. 60/557,501 and filed Mar. 30, 2004, which application is assigned to the Assignee of the present invention and is hereby expressly incorporated by reference as part of the present disclosure.

The present disclosure relates generally to the field of shopping and/or advertising. More particularly the present disclosure relates to a computer based interactive guiding assistance apparatus and method and still more particularly to a system suitable to provide individuals a more effective and efficient shopping experience while at a venue.

As products become more complex and are integrated with more and more service choices, consumers can benefit from ways to empower their decision making experience. Readily available pertinent product and/or service information can assist a consumer in making reliable informed purchase decisions as desired. For example, the Internet is a tool that is fast becoming a resource to which consumers readily look to for obtaining more detailed product and/or service information prior to making any purchase decisions. While the Internet and other similar resources commonly looked to for product information (e.g., news papers, commercials, advertisements, mailings, etc.) are certainly valuable to consumers, such resources are only practically and/or efficiently available remotely from shopping venues. Consequently, as it is often the case that a consumer's needs and/or wants change from the time of initial research to the time the consumer is at a shopping venue, it would be advantageous to provide an interactive product information resource suitable to educate a consumer as to any of a variety of products as desired and/or according to a consumer profile as well as to guide or direct such consumer to one or more targeted items of interest located at the shopping venue.

Although various in-store shopping systems are known and currently available, consider, for example, the personal shopping system disclosed by Teicher et al. in International PCT Patent Publication No. WO 98/18094, the retail location shopping assistance method and apparatus disclosed by Molbak et al. in International PCT Patent Application No. WO 01/20527 A1, the method and system for dynamic tracking of a customer disclosed by Cato in European Patent No. EP 1 197 905 A2, the interactive shopping system disclosed by Sloane in U.S. Pat. No. 6,434,530, and/or the biometric system for identifying a customer upon entering a retail establishment disclosed by Denimarck et al. in U.S. Patent Application Serial No. 2003/0018522 A1, none are suitable to provide a consumer with means for obtaining real-time product information as desired and/or according to a predefined shopping profile as well as means for guiding the consumer to the exact location of one or more targeted items of interest located at the shopping venue. Accordingly, their remains a need to provide a system that provides manufacturers, retailers and consumers with an efficient way to effectively and interactively communicate regarding manufacturer product information, product availability and/or location, and/or consumer shopping preferences. Moreover, there remains a need to provide such a system that is further capable of utilizing both historic data as well as current, real-time data.

One aspect of the present invention is directed to a guiding assistance system for use within a predefined area such as a shopping venue. In an illustrative aspect of the present invention wherein the system is operatively associated with a venue (e.g., a store, a hospital, a warehouse, or other similar establishment) the system includes at least one venue data processor, interactive venue input/output operatively associated with the venue data processor, and interactive indicator or guide operatively associated with the venue data processor and suitable for directing an individual to one or more targets items or objects in a venue via audible signals, visual signals, or tactile signals, or some combination of the same. The venue data processor, the interactive input/output and the interactive guide are operatively connected to items within the venue or predefined area so as to enable one or more individuals to find and learn about such items as desired in real time while at or within the shopping venue or predefined area. The guiding assistance system of the present invention advantageously addresses the above-identified needs.

Another aspect of the present invention is directed to a portable application that may, for example, be operatively associated with a portable device such as a mobile phone or the like. The portable device, in one aspect of the present invention, can have a local data processor suitable for selectively communicating with the venue data processor and/or database, local communicating interface operatively associated with the data processor, and local guide operatively associated with both the local communicating interface and the local data processor. The portable device, in another aspect of the present invention, can be operatively associated with a remote database and a key provided for enabling an individual to establish, control and/or otherwise manipulate communication parameters so that the individual can determine the quality and extent of information communicated to and from the venue. Thus, the portable application advantageously allows an individual to interactively communicate with the venue via, for example, the venue data processor at any time while the individual is in the venue or predefined area to effectively and efficiently inform, direct and guide the individual through the venue as desired.

Still another aspect of the present invention is directed to a method comprising the steps of providing a venue with a venue data processor and input/output operatively associated with the venue data processor, providing interactive guide operatively associated with the venue data processor, one or more individuals receiving input and/or providing output via the input/output; and guiding one or more individuals to one or more items within the venue in response to the received input or the provided output, or some combination of the same.

So that those having ordinary skill in the art to which the present invention pertains will more readily understand the disclosure described herein and methods, processes and systems for implementation thereof, exemplary aspects thereof will be discussed in association with the appended figures, wherein:

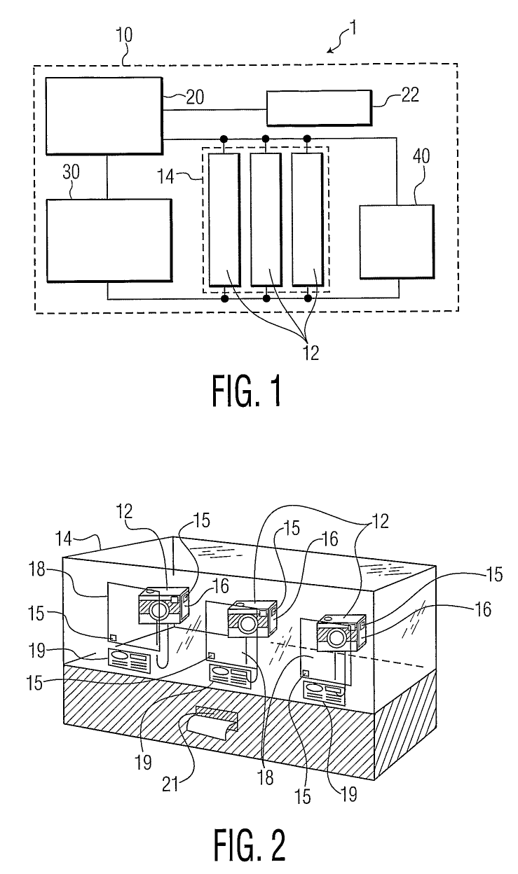

FIG. 1 is a schematic block diagram of an interactive shopping system in accordance with an illustrative aspect of the present invention;

FIG. 2 is a schematic diagram of an exemplary item identification arrangement in accordance with another illustrative aspect of the present invention;

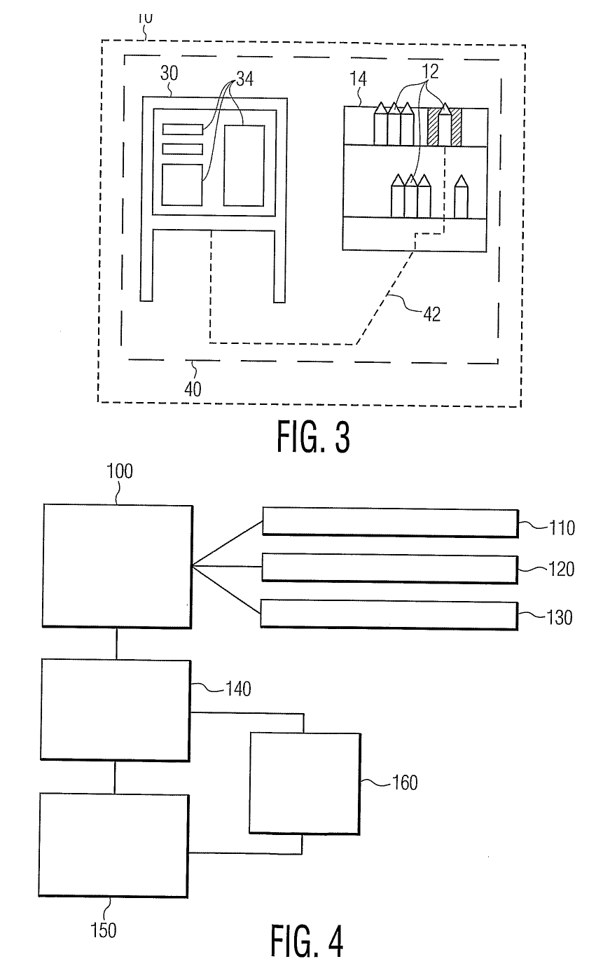

FIG. 3 is a schematic diagram of an exemplary shopping venue guide in accordance with still another illustrative aspect of the present invention;

FIG. 4 is a flow chart diagram of a method for shopping in a shopping venue in accordance with yet another illustrative aspect of the present invention;

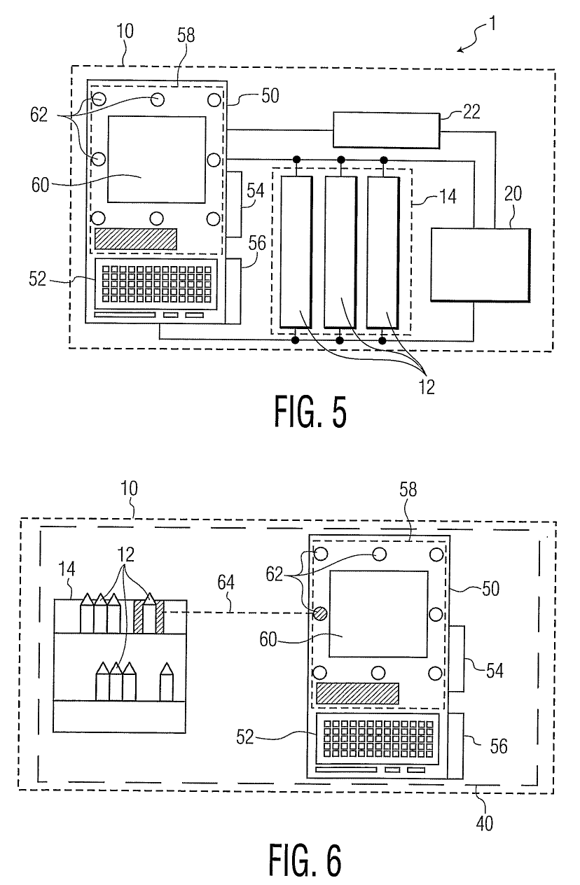

FIG. 5 is a schematic block diagram of an interactive shopping apparatus in accordance with a further illustrative aspect of the present invention;

FIG. 6 is a schematic diagram of an exemplary portable apparatus guide in accordance with still a further illustrative aspect of the present invention; and

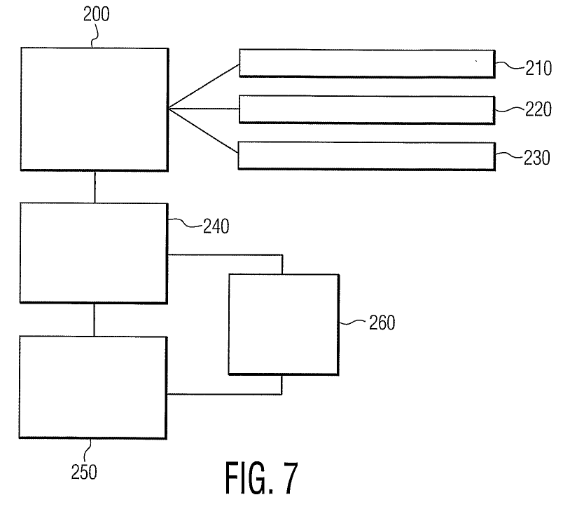

FIG. 7 is a flow chart diagram of a method for shopping in a shopping venue in accordance with yet a further illustrative aspect of the present invention.

The present disclosure is directed to an advantageous interactive guiding assistance system 1 illustratively shown in diagrammatic and block form in FIG. 1. As shown, the system 1, in an exemplary embodiment of the present invention, is operatively associated with a venue 10. The system 1 preferably includes at least one venue data processor 20, at least one venue input/output 30, and at least one venue guide 40.

The venue 10, according to the present invention, may preferably represent any of a variety of different establishments including, for example, exhibition and/or commercial arenas, retail and/or wholesale distribution outlets, hospitals, warehouses or any other like establishment. Accordingly, notwithstanding the variety of establishments to which the present invention may be associated, in an effort to judicially describe the present invention, the discussion hereinafter is directed to an exemplary embodiment of the present invention wherein the system 1 is associated with a shopping venue wherein various items 12 for sale can be provided and/or made available to potential buyers or shoppers. These items 12 may preferably be provided in any of a variety ways. For example, the items 12 can be provided via one or more display structures 14 (e.g., shelves, racks, basins, etc.) suitable to effectively present the various items 12 to shoppers. The items 12 can be arranged in any of a variety of predefined patterns throughout the venue 10, such as, for example, the items 12 may be arranged by type, price, availability, etc. in one or more pathways so as to grant effective access to such.

Referring now to FIG. 2, each item 12 preferably has at least one identifier 15 operatively associated therewith. Such identifier 15 can be directly connected to each item 12 via a tag 16 or the like on each item 12. The tag 16 can be electronic and/or suitable to convey, electronically and/or otherwise, information about the item 12 to which the particular tag 16 is associated (e.g., item type, item location, related promotions, advertisements, sales and the like, etc.). In addition or alternatively, the identifier 15 may be indirectly associated with each item 12 via a display structure 14 so as to be adjacent the item 12 to which it identifies. For example, the identifier 15 can be a display 18 (e.g., CRT screen, LCD, LED, plasma and/or the like) having an interface 19 operatively associated therewith so as to provide a shopper with means for interactively communicating with the venue data processor 20. The shopper interface 19 can take any of a variety of different forms. For example, the interface 19 may be a tactile interface (e.g., a touch screen, a keypad, etc.) and/or an audio interface (e.g., a computer aided speaker system). In an aspect of the present invention, the display 18 and/or the interface 19 can be operatively associated with a printer 21 so as to allow individuals to print out item information in hardcopy form.

Referring again to FIG. 1, the shopping venue data processor 20, in an aspect of the present invention, is preferably suitable, and/or operatively associated with at least one venue database 22, for storing information (e.g., retail price, sale price, product location, manufacturer advisements, etc.) pertaining to each item 12 located in the venue 10. The venue data processor 20 and/or venue database 22 may also preferably be suitable for storing individual shopping information (e.g., shopper profile, shopping habits and/or other user preferences, etc.) and/or for storing shopping venue information (e.g., promotions, advertisements, sales, quantities available, best selling items, which items/models are new, etc.). In addition, the venue data processor 20 and/or venue database 22 can, using the information stored therein, facilitate providing shoppers with non-intuitive purchase suggestions. That is, by examining and/or correlating stored information via sophisticated data analysis, for example, it may be determined that shoppers buying particular item types tend to prefer and/or benefit from information for certain other un-related item types. Thus, stored information may be used and/or manipulated in connection with the system, apparatus and method of the present invention to provide shoppers with an enhanced shopping experience.

The venue data processor 20 and/or the venue database 22 may be located in the venue 10 or at a remote location operatively connected to the venue 10. The venue data processor 20 and/or the venue database 22 may also be suitable to communicate with remote sites. For example, the venue data processor 20 and/or the venue database 22 can be operatively connected via a network (e.g., internet, intranet, etc.) to one or more other data processors and/or databases so as to allow shoppers and/or potential shoppers to communicate with the venue data processor 20 and/or the venue database 22. The shoppers thereby may access, review and/or manipulate information pertaining to shopping preferences, advertisements, sales, etc.

As shown in FIG. 1, the venue input/output 30 is preferably located in the venue 10 and operatively associated with the venue data processor 20 and/or the venue database 22. The venue input/output 30 is preferably easily accessible for convenient shopper utilization. The venue input/output 30 can be interactive or mechanical. The venue input/output 30 is preferably fixedly located at a predefined area optimal for shopper convenience. For example, as shown in FIG. 3, the venue input/output 30 can be a kiosk 32, or the like, located near the shopping venue entrance or perhaps at the center of the venue 10. It is noted however, that in another exemplary embodiment of the present invention, a portable device 50, such as shown in FIG. 6, for example, may have a local input/output 52 operatively associated with the venue data processor 20 and/or the venue database 22 as desired. The portable device 50 can be a handheld and/or wearable device suitable for being carried and/or worn by a shopper. More about the portable device 50 will be discussed hereinafter.

The venue input/output 30 may utilize any of a variety of different interactive venue I/O interfaces 34. For example, the venue I/O interface 34 can have a tactile input such as a keyboard, a touch screen, a mouse, joystick, track ball or any other like tactile scheme. The venue I/O interface 34 may, in addition or alternatively, employ an audio input such as audio voice recognition and/or handwriting recognition devices and measures, or any other similar audio scheme. Still further, the venue I/O interface 34 can have a visual scheme such as a motion sensor or a card reader or the like. The venue I/O interface 34 can also have any of a number of output schemes including, for example, a CRT screen, LCD display, LED display and/or similar visual systems. Various known audio (e.g., voice recognition) and/or tactile (e.g., printer) output schemes as known to those skilled in the art may also be utilized.

The venue input/output 30 is preferably suitable for receiving and transmitting data information to and from any of a variety of other electronic devices. For example, the venue input/output 30 can have electronics for communicating with a wireless device (e.g., a cell phone, a portable computer, or other like device). Thus, the venue input/output 30 may, in aspects of the present invention, be remotely accessed by shoppers at any time and/or from any of a variety of locations both within and without the venue 10. Data communication between the venue input/output 30 and the venue data processor 20, the venue database 22 and/or a remote device may be accomplished by any of a variety of known communication schemes. For instance, the data communication may be accomplished via local area network, internet, telephone, cabling, infrared, radio, satellite, etc, or any combination thereof.

As shown in FIG. 1, the venue guide 40, like the shopping venue input/output 30, is preferably located in the venue 10. The venue guide 40 is preferably operatively associated with the venue data processor 20 and/or the venue database 22, as well as the venue input/output 30 so as to effectively and efficiently direct or guide shoppers to items 12 of interest in the venue 10. The venue guide 40 may communicate with the venue data processor 20 and/or the venue database 22, as well as the venue input/output 30 in any of a variety of ways, including, for instance, by local area network, internet, telephone, data communication cabling, infrared, radio, satellite, or other wireless and/or any other appropriate communication scheme. In a preferred aspect of the present invention, a shopper interacts with the system 1 and/or the venue 10, preferably in real time, via the venue input/output 30 and the venue guide 40.

The venue guide 40 can take a variety of forms. For example, as shown in FIG. 3, in an illustrative aspect of the present invention the venue guide 40 is a visual display scheme (e.g., track lighting, e-display, e-ink or other like scheme) integral with the venue 10. In this aspect, shoppers entering the venue 10 can be identified and assigned a color (e.g., red, blue green, etc.). Shoppers inputting information and/or queries via the venue input/output 30 may, in addition to being provided with responsive information output, be visually guided directly to one or more targeted items 12 by following a lighted path 42 that may preferably be color coded so as to correspond to the shopper's assigned color. The color coded lighted path 42 may be readily visible to the shopper or visible only in association with a supplemental optical device (e.g., eyeglasses) provided to the shopper and suitable for enabling the shopper to view/identify the color coded lighted path 42 that otherwise, would not be readily discernable. In addition, the display 18 and/or the interface 19 associated with the targeted items 12 may be simultaneously highlighted, or alternatively, may be highlighted by an appropriate shopper tracking system, as may be known in the art, only when the shopper is in a predefined proximity of the targeted item or items 12.

Having identified/discussed various preferred aspects of system 1, an illustrative method for utilizing such system is now provided with reference to FIG. 4. As indicated by box 100, one or more individuals enter the venue 10 and interfaces with the venue input/output 30 to, as indicated by box 110, select a predefined mode of operation (e.g., “think for me”, “get me started”, “show me what is popular”, show me a bargain”, etc.), as indicated by box 120, enter a specific query (e.g., identify/target a specific item and/or item type), and/or as indicated by box 130, enter specific profile or identifying information (e.g., preferred brands, preferred prices, and/or any other shopping preferences), which information may be stored via the venue data processor 20 for use during subsequent shopping visits. Irrespective of the particular operating scheme employed, the individual's shopping profile/behavior may be taken into account and influence the output provided to the individual. As indicated by box 140, once the individual has searched, filtered, narrowed and/or identified items of interest, the venue guide 40 may then effectively guide the individual through the venue 10 and to the one or more items of interest via a lighted pathway in accordance with the teachings of the present disclosure. In addition, the one or more items of interest may be highlighted (e.g., via an illumination scheme) to bring the targeted item or items of interest to the attention of the individual when in a predefined proximity. Once the shopper arrives at the location of a targeted item, as indicated by box 150, the individual may again communicate with the system 1 via the display 18 and/or the interface 19 corresponding to such item so as to obtain additional information concerning the particular item and/or other related items as desired. In addition, as indicated by box 160, the individual may change operating modes, enter new queries, and/or enter new profile information at any time as desired via the venue input/output 30, as well as the display 18 and/or the interface 19.

As may be recognized by those of ordinary skill in the pertinent art, various changes and/or modifications to the system 1 and/or the illustrative method of utilization described above equally may be used. For instance, in an aspect of the present invention, the system 1 can interface/communicate with any of a variety of remote devices, such as, for example, a cell phone, pda and/or any other portable device, to allow a shopper, at anywhere within the venue 10, to access the venue data processor 20 and/or venue data base 22 (e.g., via a code) as desired. Thus, in response to a shopper's coded and/or verbal query via their personal portable device, the system 1 can communicate the appropriate response (e.g., type, location, etc. of the relevant items) also via their personal portable device. In addition, the system 1 can make any of a variety of intuitive and/or non-intuitive recommendations based on item type and/or shopper profile. Still further, system 1 can allow the shopper to filter and/or otherwise manipulate search results based on specific input (e.g., item features). That is, once the shopper has been directed to, and found a targeted item, if the shopper observes/learns of a particular feature and becomes interested therein (e.g., via the display 18), he/she may select that feature or input a query regarding that feature (e.g., via the interface 19) and in response receive a new set of options and/or search results relating to the particular feature. For instance, an option to “get more information on this feature”, “identify/locate other items with this exact feature”, or “see other items having comparable features”. Upon selecting an option and/or inputting a new query, the shopper is provided with a revised/updated list of recommended items.

Referring now to FIG. 5, as previously noted, in other aspects the present invention, the system 1 may preferably utilize an application operatively associated with one or more portable devices 50 with each having portable input/output 52 that may be operatively associated with the venue data processor 20 and/or the venue data base 22 to enable a user to interact and/or communicate with the system 1. Each portable device 50 can be operatively associated with a remote data processing means suitable to, among other things, allow access to an individual's personal database so as to enable the individual to define, control access to, or otherwise manipulate his/her personal profile (e.g., shopping profile, shopping habits, shopping preferences, etc), for example. In one aspect of the present invention, the foregoing may be accomplished via a key operatively associated with an RFID assigned to the individual user. In an alternative aspect of the present invention, each portable device 50 may have, and/or be operatively associated with, a local processor 54 and/or local database 56, as well as at least one local guide 58.

The portable input/output 52, like the venue input/output 30, can be interactive or mechanical and suitable for receiving and/or transmitting data to and from any of a variety of other electronic devices. The portable devices 50 can preferably communicate with the venue data processor 20 and/or the venue database 22 in via any of a variety of known ways. For example, over a local area network, through the internet, via telephone lines or data communication cabling, infrared means, radio means, satellite means, or any other appropriate communication scheme.

Further, as illustrated, the portable device 50 can utilize any of a variety of different interactive portable I/O input interfaces. For instance, a tactile interface such as a keyboard or a touch screen 60 may be effectively utilized. Additionally or alternatively, an audio input scheme such as, an audio voice recognition and/or handwriting recognition mechanism, or other like audio scheme equally may be utilized. Still further, a visual input indicating scheme like a motion sensor, a card reader or the like may likewise be used. The portable I/O interface preferably also utilizes any of a number of output schemes including, for example, a CRT screen, LCD display, LED display and/or any other like visual system to enable the venue system 1 to effectively communicate with the user of the portable device 50. Various known audio (e.g., voice recognition) and/or tactile (e.g., vibrator) output schemes equally may be utilized.

The local processor 54 and/or the local database 56 identified above may preferably be suitable for storing shopper information (e.g., shopper profile, shopping habits and/or preferences, etc.) and/or for storing venue information (e.g., promotions, advertisements, sales, quantities available, best selling items, which items/models are new, etc.). In addition, as with the venue processor 20 and/or venue database 22, the local processor 54 and/or the local database 56 may, using information stored therein, facilitate providing individuals with non-intuitive purchase suggestions by examining and/or correlating stored information via sophisticated data analysis. Thus, stored information that may be pertinent to an individual's shopping visit may be used and/or manipulated via the portable device and method for utilizing the same may provide individuals with an enhanced shopping experience.

The local processor 54 and/or the local database 56 may be integral with the portable device 50 or separately attachable thereto. The local processor 54 and/or the local database 56 may be suitable to communicate with remote sites. For example, the local processor 54 and/or the local database 56 can be operatively connected via a network (e.g., internet, intranet, etc.) to one or more other data processors and/or databases so as to allow shoppers and/or potential shoppers to communicate with the venue data processor 20 and/or the venue database 22. The shoppers thereby may access, review and/or manipulate information pertaining to shopping preferences, advertisements, sales, etc.

As reflected in FIG. 5, the local guide 58 can interactively communicate with the venue data processor 20, the venue database 22, the venue input/output 30, and/or the venue guide 40 in any of a variety of ways, including, for instance, by local area network, internet, telephone, data communication cabling, infrared, radio, satellite, or other wireless and/or other like communication scheme to provide a shopper with real time portable means for interacting with the store system 1. In another aspect of the present invention, each portable device 50 may have, and/or be operatively associated with, a local processor 54 and/or local database 56, as well as at least one local guide 58.

Referring now to FIGS. 5 and 6, the local guide 58 can take any of a variety of forms, including for example, a visual directing scheme, such as an illuminated pointer 62 integral with the portable device 50. In this aspect, shoppers entering the venue 10 can be provided with a portable device 50. Shoppers inputting information and/or queries via the portable device 50 may, in addition to being provided with responsive information output, be visually guided directly to one or more targeted items 12 by following the illuminated pointer 62 associated with the portable device 50 along a pathway 64. In addition, the display 18 and/or the interface 19 associated with the targeted items 12 may be simultaneously illuminated, or alternatively, may be illuminated by an appropriate shopper tracking system, as known in the art, only when the portable device 50 is in close proximity to the targeted item or items 12. In other aspects of the present invention, the portable device 50 may be provided with an audible director suitable to provide the shopper with audible directions. In still other aspects of the present invention, the portable device 50 can have a tactile or vibrating mechanism suitable to provide the audio and/or visually handicapped shoppers with direction within the venue 10. For example, the portable device 50 can be handheld and have a number of vibrators optimally positioned to provide appropriate sensations to areas of the hand so as to indicate to effectively guide the shopper using his/her sense of touch. The portable device 50 may be suitable to trigger adverts or special offers for the consumer based on their proximity, their level of profile sharing, info specific to their profile, or their mode of shopping.

Having identified/discussed various aspects of the portable device 50, an illustrative method for utilizing such portable device is now provided with reference to FIG. 7. As indicated by box 200, a shopper entering the venue 10 may be provided with a portable device 50 so as to effectively interface with the shopping venue data processor 20 to, as indicated by box 210, select a predefined mode of operation (e.g., “think for me”, “get me started”, “show me what is popular”, show me a bargain”, etc.), as indicated by box 220, enter a specific query (e.g., identify/target a specific item and/or item type), and/or as indicated by box 230, enter specific profile or identifying information (e.g., preferred brands, preferred prices, and/or any other shopping preferences), which information may be stored via the venue data processor 20 for use during subsequent shopping visits. Irrespective of the particular shopping scheme employed, the shopper's shopping profile/behavior may be taken into account and influence the output provided to the shopper. As indicated by box 240, once the shopper has searched, filtered, narrowed and/or identified items of interest, the local guide 58 and/or the venue guide 40 may then effectively guide the shopper through the venue 10 and to the one or more items of interest via a pathway 42, 64 in accordance with the teachings of the present disclosure. In addition, the one or more items of interest may be highlighted (e.g., via an illumination scheme) to bring the targeted item or items of interest to the attention of the shopper when in proximity thereto. Once the shopper arrives at the location of a targeted item, as indicated by box 250, the shopper may again communicate with the system 1 via the display 18, the interface 19, and/or the portable device 50 corresponding to the item of interest so as to obtain additional information concerning the particular item and/or other related items as desired. In addition, as indicated by box 260, the shopper may change operating modes, enter new queries, and/or enter new profile information at any time as desired via the portable device 50, as well as the display 18 and/or the interface 19.

As may be recognized by those of ordinary skill in the pertinent art based on the teachings herein, numerous changes and modifications may be made to the above-described and other aspects of the present invention without departing from the spirit of the invention as defined in the claims. For example, each portable device 50 may be provided with a locator such as a positional transponder, or the like, suitable to track the location of such portable device 50 anywhere in the venue 10. The locator may operatively cooperate with the local guide 58 to more effectively direct the shopper to any of a variety of locations within the venue 10, and to allow the store to more effectively interact and/or communicate with the shopper (e.g., modify advertising or promotions). The portable device 50 may also take any of numerous different shapes, sizes and/or configurations suitable for convenient portability and effective use. Likewise, the various components of the system 1 may be made of any of a variety of different materials that are currently or later become known for performing the functions of such components. Further, each of such components may further take any of numerous different shapes and/or configurations. Accordingly, this detailed description of currently preferred aspects is to be taken in an illustrative, as opposed to a limiting sense.

What is claimed is:

1. An apparatus operatively associated with a portable application for use in a venue (10), said apparatus comprising:
data processing means (54) for selectively communicating with a venue data processor (20);
input/output means (52) operatively associated with said data processing means (54); and
guide means (58) operatively associated with both said communication means (52) and said data processing means (54).

2. The apparatus of claim 1, wherein said data processing means (54) is a microprocessor in a handheld device (50) with said input/output means (52) for enabling an individual to input desired information and to receive responsive output.

3. The apparatus of claim 1, wherein said data processing means (54) is a remote data processor operatively associated with a handheld device (50).

4. The apparatus of claim 3, wherein said remote data processor allows selective access to an individual's personal database.

5. The apparatus of claim 4, wherein said selective access is associated with an RFID.

6. The apparatus of claim 4, wherein said selective access enables an individual to define, to control access to, or otherwise manipulate a personal profile.

7. The apparatus of claim 2, wherein said input/output means (52) is an interactive interface operatively associated with a handheld device (50) enabling the individual to effectively communicate with said venue data processor (20) in real time while at the venue (10).

8. The apparatus of claim 1, wherein said guide means (58) is an interactive indicator operatively associated with a handheld device (50).

9. The apparatus of claim 8, wherein said interactive indicator (58) directs an individual to one or more items in the venue via at least one of an audible signal, a visual signal, or a tactile signal.

10. The apparatus of claim 8, wherein said interactive indicator (58) and said input/output means (52) operatively cooperate to provide an individual with information based on at least one of: an individual's particular location within said venue, an individual's level of profile sharing, an individual's specific data profile, or an individual's preferred operating mode.

11. The apparatus of claim 8, wherein said interactive indicator (58) and said input/output means (52) cooperate to remind individuals of specific information associated with their profile.

12. The apparatus of claim 1, wherein said guide means (58) is operatively associated with a portable device (50) so as to cooperate with a venue guide means (40).

13. The apparatus of claim 12, wherein said venue guide means (40) is an illumination system operatively associated with the venue (10).

14. The apparatus of claim 1, wherein said communicating means (52) is an interactive input/output operatively associated with one or more portable devices (50) or the venue (10).

15. A guiding assistance system (1) for use within a venue (10), comprising:
at least one venue data processor (20);
interactive input/output means (30) operatively associated with said venue data processor (20); and
interactive indicator means (40) operatively associated with said venue data processor (20) and suitable for directing an individual to one or more items (12) via audible signals, visual signals, or tactile signals, or some combination of the same.

16. The system of claim 15, wherein said interactive input/output means (40) is operatively associated with a portable device (50).

17. The system of claim 15, wherein said interactive input/output means is a kiosk optimally located within the venue (10).

18. A method comprising the steps of:
providing a venue data processor (20) and input/output means (30, 52) operatively associated with said venue data processor (20);
providing interactive guide means (40, 58) operatively associated with said venue data processor (20);
receiving input and providing output via said input/output means (30, 52); and
guiding one or more individuals to one or more items (12) within the venue (10) in response to said received input or said provided output, or some combination of the same.

19. The method of claim 18, wherein said input/output means (30, 52) is one or more portable devices (50) or a kiosk located within said venue (10) and said interactive guide means (40, 58) is an illumination system located throughout said venue (10).

20. The method of claim 18, wherein said venue data processor (20), said input/output means (30, 58) and said interactive guide means (40, 58) are operatively connected to items (12) in said venue (10) so as to enable one or more individuals to find and learn about such items (12) as desired in real time while at the venue (10).
